(19) United States
(12) Patent Application Publication
(10) Pub. No.: US 2025/0391057 A1
(43) Pub. Date: Dec. 25, 2025

(54) AUTOMATIC EXTRINSIC CAMERA CALIBRATION USING A PROJECTED PATTERN

(71) Applicant: Intrinsic Innovation LLC, Mountain View, CA (US)

(72) Inventors: Kartik Venkataraman, San Jose, CA (US); Raghav Khanna, Zurich (CH); Agastya Kalra, Palo Alto, CA (US)

(21) Appl. No.: 19/244,684

(22) Filed: Jun. 20, 2025

Related U.S. Application Data
(60) Provisional application No. 63/662,856, filed on Jun. 21, 2024.

(51) Int. Cl. G06T 7/80; G06T 7/32; G06T 7/60; H04N 13/246

(52) U.S. Cl. CPC G06T 7/85; G06T 7/32; G06T 7/60; H04N 13/246; G06T 2207/10012; G06T 2207/10028

(57) ABSTRACT

Methods, systems, and apparatus, including computer programs encoded on a computer storage medium, for computing one or more calibration parameters using a projected pattern. In one aspect, a method comprises projecting a pattern having a plurality of shapes in an environment using a projector, capturing images of the pattern from at least two different cameras, determining one or more geometric features of shapes in the captured images and correspondences between the geometric features for a pairing of cameras in the at least two different cameras, and computing one or more calibration parameters for the pairing of cameras according to the correspondences between the geometric features in the captured images.

### CLAIM OF PRIORITY

This application claims priority under 35 USC § 119(e) to U.S. Patent Application Ser. No. 63/662,856, filed on Jun. 21, 2024, the entire contents of which are hereby incorporated by reference.

### BACKGROUND

This specification relates to robotics, and more particularly to controlling robotic movements.

Robotics control refers to scheduling the physical movements of robots in order to perform tasks. These tasks can be highly specialized and in some cases can be directed at a workpiece that the robot can manipulate. For example, an industrial robot that builds cars can be programmed to first pick up a car part and then weld the car part onto the frame of the car. As another example, a robot can pick up components for placement on a printed circuit board. Programming a robot to perform these actions can require planning and scheduling dozens or hundreds of individual movements by robot motors and actuators. For example, the actions of the robot can be accomplished by one or more end effectors mounted at the end, or last link of one or more moveable components, of the robot that are designed to interact with the environment, workpiece, or both.

This specification also relates to robotic vision systems that can be used to control robotic movements. Generally, robots use multiple vision sensors to perceive the workcell. In particular, the actions of a robot can be monitored and informed by multiple cameras mounted in the workcell of the robot. In this specification, a workcell is the physical environment in which a robot operates. Workcells have particular physical properties, e.g., physical dimensions, that impose constraints on how a robot can move as well as what can be perceived by the cameras mounted within the workcell. In this case, each camera can capture images that provide a particular viewpoint of the workcell.

In the case where there are multiple cameras mounted in the workcell of the robot, proper functionality of the robotic vision system depends on the calibration of one or more camera parameters, e.g., a set of intrinsic parameters, a set of extrinsic parameters, and a camera-to-camera transform.

Since cameras cannot be located in the exact same location in the work cell, each camera has a different viewpoint and can therefore capture images that provide information in a particular coordinate system. This information can be unified using a camera-to-camera transform that provides a change of coordinates between each pairing of cameras in the workcell, e.g., by defining the relative position and orientation of a first camera's coordinate system relative to a second camera's coordinate system. As an example, this change-of-coordinates can be defined as an extrinsic transformation matrix. An accurate camera-to-camera transform ensures that the robot can aggregate information from the multiple cameras in a meaningful way, thereby ensuring proper functionality of the robot, especially in real-time control systems.

A real-time control system uses a real-time controller to dictate what action or movement a robot should take during every period of a control cycle. In this specification, a real-time control system is a software system that is required to perform actions within strict timing requirements in order to achieve normal operation. The timing requirements often specify that certain processes must be executed or certain outputs must be generated within a particular time window in order for the system to avoid entering a fault state. In the fault state, the system can halt execution or take some other action that interrupts normal operation of a robot.

### SUMMARY

This specification describes a system implemented as computer programs on one or more computers in one or more locations that can perform extrinsic camera calibration using a projected pattern. For example, the system can compute a camera-to-camera transform for a pairing of cameras in a workcell by establishing a correspondence between images of the pattern captured with the different cameras.

In this specification, a camera-to-camera transform refers to a set of parameters that can be used to perform a transformation between the coordinate system of a first camera and the coordinate system of a second camera. For example, the camera-to-camera transformation can parameterize the relative position and orientation of the cameras with respect to a common coordinate system. As an example, the camera-to-camera transform can be an extrinsic transformation matrix that parameterizes the extrinsic camera calibration between the two cameras.

According to a first aspect there is provided a method for projecting a pattern having a plurality of shapes in an environment using a projector, capturing images of the pattern from at least two different cameras, determining one or more geometric features of shapes in the captured images and correspondences between the geometric features for a pairing of cameras in the at least two different cameras, and computing one or more calibration parameters for the pairing of cameras according to the correspondences between the geometric features in the captured images.

Particular embodiments of the subject matter described in this specification can be implemented so as to realize one or more of the following advantages.

The system of this specification can compute one or more calibration parameters including the intrinsic parameters, extrinsic parameters, and camera-to-camera transform for multiple cameras simultaneously in any arbitrary environment. In particular, the system can perform an automated in-situ calibration without an explicit calibration target. Thus, this technique can be applied to various camera setups, including complex multi-camera setups, and environments without the need for inserting specialized calibration targets or markers.

Traditional marker-based methods can be unreliable in demanding production environments, as maintaining a calibration's integrity over extended periods of time can be both challenging and costly. By projecting a pattern into the environment, the system can insert a target into the environment, thereby removing the need to use a physical target and allowing the system to operate in any arbitrary environment. Additionally, the techniques of this specification allow for the computing, adjusting, and validating of the calibration parameters in real-time production systems without impact to productivity.

For example, the system is able to perform the extrinsic calibration process without the need to halt robotic functioning, thereby reducing production downtime. Existing techniques often rely on precise, specialized calibration targets or markers, which can require manual intervention to carefully set up in an environment. Moreover, the system can also be used to determine and correct any calibration drift in the intrinsic parameters, extrinsic parameters, and camera-to-camera transform as a result of camera movements over time, thereby enhancing automated processes in industrial environments which can be recalibrated without the need for production downtime.

Furthermore, the system can achieve robust correspondence between a pairing of cameras for the purposes of three-dimensional reconstruction across complex geometries, environments, and materials in industrial settings, including mechanical, thermal, and light fluctuations (e.g., active illumination vs. lights-out manufacturing), e.g., for robotic manipulation and collision avoidance. In particular, the system can calibrate a robot to handle the complexity of industrial settings, with challenging lighting, material, and geometry scenarios.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example extrinsic camera calibration system.

FIG. 2 is a flow chart of an example process for determining one or more calibration parameters for a pairing of cameras using a projected pattern.

FIG. 3 illustrates the determination of a correspondence using a single stereo unit, and the determination of the transformation function between the stereo unit and a paired stereo unit.

FIG. 4 includes a comparison of example results from the calibration system of this specification and a checkerboard method.

FIG. 5 illustrates how calibrating cameras using the calibration techniques of this specification can enhance the reconstruction of an example scene.

Like reference numbers and designations in the various drawings indicate like elements.

### DETAILED DESCRIPTION

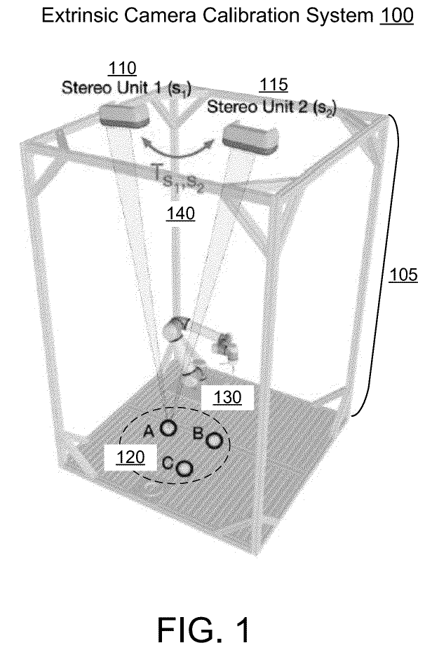

FIG. 1 shows an example extrinsic camera calibration system 100. The extrinsic camera calibration system 100 is an example of a system implemented as computer programs on one or more computers in one or more locations in which the systems, components, and techniques described below are implemented.

The extrinsic camera calibration system 100 can include at least two cameras, e.g., the stereo unit 1 110 and the stereo unit 115. The system 100 can be used to compute one or more calibration parameters for the pairing of the cameras 110 and 115, e.g., the system 100 can compute one or more of a set of intrinsic parameters, a set of extrinsic parameters, and a camera-to-camera transform.

In the particular example depicted, the system 100 can compute the camera-to-camera transformation 140 between the two cameras 110 and 115 using a projected pattern 120 in the environment, e.g., the workcell 105. The extrinsic calibration of two cameras, e.g., Camera A and Camera B, involves estimating the relative rotation ^{A}R_{B} and translation ^{A}t_{B} that transforms points expressed relative to Camera B's coordinate system, e.g., p_{B}, to points expressed relative to Camera A's coordinate system: p_{A}=^{A}R_{B}*p_{B}+^{A}t_{B}. This information can be used to inform the real-time control of a robot, e.g., the robot 130.

In particular, the extrinsic camera calibration system 100 can be included in a real-time control system that can control a robot to perform the actions of a robot program. The robot program can be a set of encoded instructions that specify how the robot should perform a particular task with respect to an object of interest, a desired movement to be taken in the workcell 105, etc. When executed by an appropriately programmed real-time or non-real-time computer system the robot program can provide a goal pose to an interaction controller that can define waypoints specifying the robot's configuration in the next desired pose, e.g., a desired position and orientation for each of the one or more movable components of the robot 130. For example, the next desired pose can be achieved using a position controller that can send control signals as a command to the robot 130 to achieve the next waypoint, e.g., by controlling the robot 130 to move the one or more moveable components according to the command.

For example, the control signals can be used to control the robot, e.g., via low-level controllers, such as low-level joint position controllers or low-level torque controllers, to move the one or more moveable components according to the command specified by the control signals. In some cases, the control signals can direct the robot to interact with a workpiece, e.g., a raw material, a manufactured item, several components of an item that can be put together, etc. The motion of the robot can provide a response back to the interaction controller that can be used to inform the next control cycle, e.g., with respect to achieving the next waypoint.

In some cases, e.g., in precision robotics applications such as visual servoing and pose estimation, the robot 130 can use one or more visual sensors, e.g., one or more cameras, to inform the next control signal. For example, the one or more cameras can provide data that can be used to inform the command needed for the next desired pose.

In the particular example depicted, the one or more cameras are implemented as stereo units, e.g., stereo unit 1 110 and stereo unit 2 115. Stereo units are cameras that capture images with binocular vision, e.g., each stereo unit includes two cameras. In this case, the images can represent a two-dimensional or a three-dimensional view of the environment, e.g., the workcell 105. For example, the use of binocular vision can provide three-dimensional depth information, e.g., data which can be used to construct a point cloud, as will be described in more detail below.

In this case, the system 100 uses a projector, e.g., a light projector mounted in one of the stereo units, e.g., stereo unit 110 or 115, to project a pattern 120 onto the environment, e.g., the workcell 105. The projector can be a calibrated projector or an uncalibrated projector, e.g., a projector that has not been calibrated to match a color, brightness, contrast, sharpness, etc. standard reference. The pattern can be any arbitrary arrangement of shapes that can be used to detect geometric features of the shapes, e.g., centroids, corners, etc. For example, the pattern can be a pseudorandom grid of dots, e.g., as depicted. As another example, the pattern can include an arrangement of Ls, e.g., as described in OpenCV, 2015. Open Source Computer Vision Library. In some cases, the projector can be configured to project the pattern at a wavelength to ensure that the pattern is visible in high ambient illumination environments, e.g., an infrared or near-infrared wavelength. As an example, the wavelength can be 940 nm.

The extrinsic camera calibration system 100 can capture images of the pattern 120 using the stereo units 110 and 115 and can determine a correspondence between a first image of the pattern from the viewpoint of stereo unit 110 and a second image of the pattern from the viewpoint of stereo unit 115. In this context, a correspondence is a defined relationship between the detected geometric features of the shapes of the pattern in the first and second images. For example, the system can use a measure of brightness for each shape in the first and second image to detect the geometric features of the pattern 120 in each image. The system 100 can then use the detected geometric features of the pattern 120 to determine the correspondence across viewpoints with respect to the pattern 120 in the two-dimensional view of the environment provided by the first and second image.

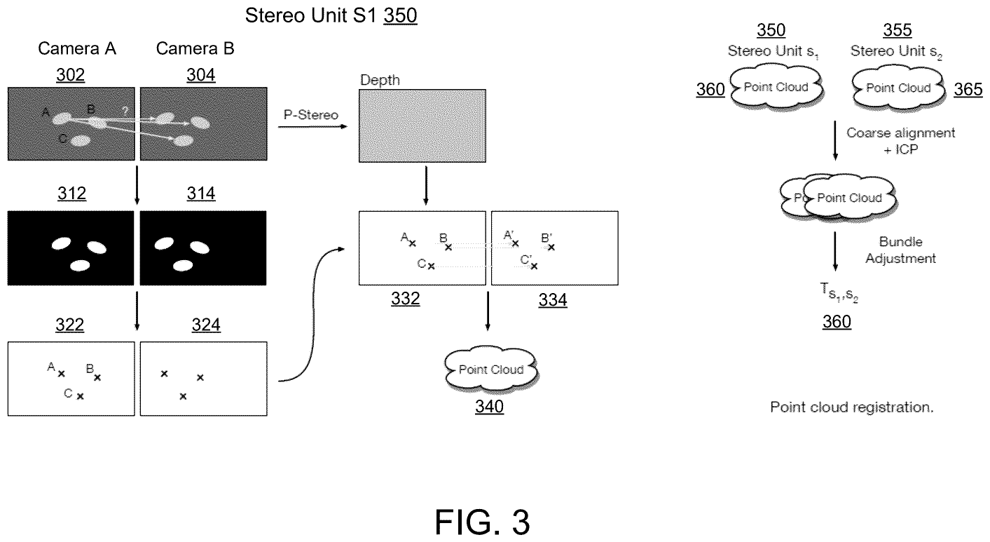

For example, the system 100 can compute the camera-to-camera transform 140 using the determined correspondence between the geometric features in the captured images. As an example, the system 100 can construct a point cloud, e.g., a three-dimensional view of the environment, for each stereo unit 110, 115. In particular, the two cameras in each stereo unit provide for depth perception through stereopsis, e.g., the disparity between the positions of the shapes of the patterns in the images of the two cameras in each stereo unit can be used to perceive three-dimensional information. This three-dimensional information can be used to inform the correspondence between the geometric features in the captured images, as is depicted with respect to FIG. 3.

In this case, the system 100 can construct a first point cloud for the stereo unit 110 and a second point cloud for the stereo unit 115, can compute point feature histograms for the first and second point clouds, and can use features of the point feature histograms to determine a camera-to-camera transform 140. As an additional example, the system 100 can use an iterative closest point algorithm to align the points in the first point cloud and the points in the second point cloud using an extrinsic transformation matrix.

In some cases, the system 100 can compute and refine a coarse camera-to-camera transform, e.g., an initial extrinsic transformation matrix, for the pairing of cameras. For example, the system 100 can compute a coarse camera-to-camera transform as described above and can optimize the camera-to-camera transform 140, e.g., by using bundle adjustment optimization to minimize a measure of discrepancy between the points of a correspondence set, as will be described below. In some cases, the system can employ one or more additional iteration(s) of the iterative closest point algorithm to further align the points in the first point cloud and the second point cloud before using bundle adjustment optimization.

For example, the system 100 can determine a correspondence set of points that includes a pairing of points from the first and second point clouds using the detected geometric features and the initial extrinsic transformation matrix. As an example, the system 100 can determine the points of the first point cloud that correspond with each detected geometric feature in the first image as the first point in a pairing of points and can map the first points from the correspondence set to the viewpoint of the other camera, e.g., the system 100 can apply the coarse camera-to-camera transformation to the first points in the correspondence set to generate a mapped set of points in the viewpoint of the second camera. The system 100 can then identify the nearest corresponding points in the second point cloud to each mapped point as the second point in the pairing of points in the correspondence set.

In the case that the system 100 computes and refines a coarse camera-to-camera transform, the system 100 can use bundle adjustment optimization to minimize a measure of discrepancy between the pairing of points in the correspondence set, e.g., based on the positional uniformity of detected geometric features across all camera views. For example, the system 100 can minimize the measure of discrepancy at each of a number of optimization iterations using any appropriate non-linear least squares optimization techniques. As an example, the system 100 can use Levenberg-Marquardt or Gauss-Newton optimization to iteratively adjust parameters in the camera-to-camera transform to minimize the measure of discrepancy. In particular, the system 100 can minimize the reprojection error, e.g., the difference between the projected points using the parameters in the camera-to-camera-transform and the observed two-dimensional detected geometric features at each optimization iteration. In some cases, the system 100 can minimize the discrepancy across different sets of images taken with each respective camera.

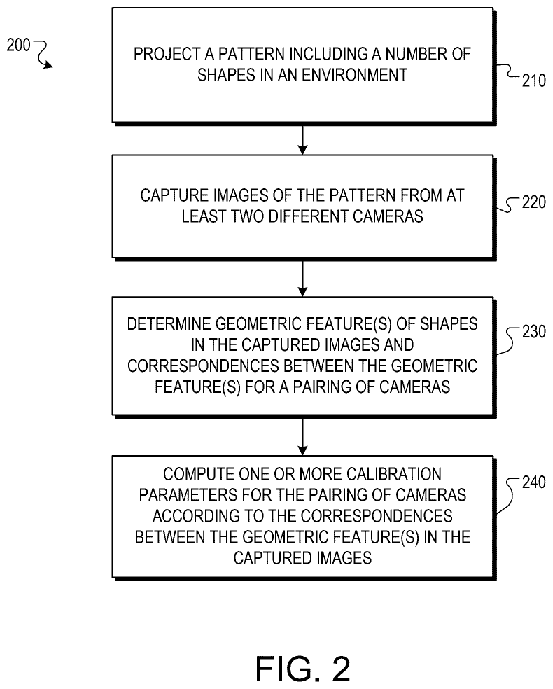

FIG. 2 is a flow diagram of an example process for determining one or more calibration parameters for the pairing of cameras using a projected pattern. For convenience, the process 200 will be described as being performed by a system of one or more computers located in one or more locations. For example, an extrinsic camera calibration system, e.g., the extrinsic camera calibration system 100 of FIG. 1, appropriately programmed in accordance with this specification, can perform the process 200.

The system can project a pattern including a number of shapes in an environment using a projector (step 210). In particular, the system can use a light projector to project a pattern in the environment of a robot, e.g., a workcell. The projector can be a calibrated projector or an uncalibrated projector, e.g., a projector that has not been calibrated to match a color, brightness, contrast, sharpness, etc. standard reference. As an example, the pattern can include a pseudorandom grid of dots, an L pattern, etc. In some cases, the pattern can be projected at a wavelength that is visible in high ambient illumination environments. In some examples, projecting the pattern can involve projecting the pattern using a first projector, e.g., from a first camera, and projecting the pattern using a second projector, e.g., from a second camera.

The system can capture images of the pattern from at least two different cameras (step 220). In particular, the at least two different cameras can be at least two stereo units, where each stereo unit includes two cameras. In this case, the use of “camera” below can refer to a single stereo unit. As an example, the system can capture a background image of the environment without the pattern and a pattern image of the environment with the projected pattern, and can subtract the background image from the pattern image to generate an image for each camera. In the case that the system projects the pattern using different projectors, the system can capture the background images with the first and second cameras, project the pattern using the first projector from the first camera and capture images of the pattern with the two different cameras, and project the pattern using the second projector from the second camera and capture images of the pattern with the two different cameras. In this case, the system can subtract the background image from each pattern image to generate the images.

The system can determine one or more geometric features of shapes in the captured images and correspondences between the geometric features for a pairing of cameras in at least two different cameras (step 230). In particular, the system can detect a first set of geometric features corresponding with the shapes in a first image captured from the first image and a second set of geometric features corresponding with the shapes in a second image captured from the second camera and can use the first and second sets of geometric features to determine the correspondences between the geometric features. As an example, the geometric features can include detected centroids or corners of each shape in the pattern included in the first and second image.

More specifically, the system can detect the first set of geometric features for the first image and the second set of geometric features for the second image using a measure of brightness of each of the shapes in the first and second images. For example, the system can generate a respective pattern representation including elongated shapes by blurring the first and second image, e.g., by blurring with a Gaussian function, and can determine the geometric feature of each of the elongated shapes in the pattern representation. In this case, blurring the shapes facilitates the detection of the geometric feature. In particular, the system can estimate a point of maximal brightness of each elongated shape using a sliding window, e.g., by performing local maxima detection within a sliding N×N (e.g., where N is 3, 7, 12, etc.) pixel window, can determine a quadratic fit around the estimated point of maximal brightness for the elongated shape, e.g., by fitting a quadratic function to an M×M (e.g., where M is 5, 10, 15, etc.) pixel window, and can identify a vertex of the quadratic fit as the geometric feature for the elongated shape.

In some cases, the system can rank the geometric features detected for each elongated shape, e.g., according to a measure of brightness, e.g., intensity, and can select a subset of the geometric features based on the measure of brightness for determining correspondence. For example, the system can select the top 100, 500, or 1000 geometric features per image for subsequent correspondence establishment.

For example, the system can construct a first point cloud corresponding with the first camera and a second point cloud corresponding with the second camera, e.g., using the disparity between the images from the two cameras in each stereo unit. In particular, the system can identify a correspondence set of points that can be used to align the point of the first point cloud with the point of the second point cloud, e.g., using an iterative closest point algorithm.

For example, for each detected geometric feature, the system can determine a point from the first point cloud that corresponds with the geometric feature as a first point in a pairing of points, can map the first point to a mapped point in a viewpoint of the second camera using the initial extrinsic transformation matrix, and can identify a nearest corresponding point to the mapped point in the second point cloud within a specified threshold distance, e.g., 2, 5, 10 pixels, as a second point in the pairing of points. In particular, the system can remove points that are not within the specified threshold distance to account for occlusions and non-overlapping regions of the first and second camera images.

In some cases, the system can perform a correspondence refinement algorithm, e.g., an optical flow technique, to compute respective sub-pixel corrections for the first and second points in each pairing of points in the identified correspondence set. In some cases, the system can periodically refine the correspondence to detect and correct any potential drift, in order to ensure ongoing calibration accuracy, without the need for manual intervention.

For example, the system can use the Lucas-Kanade correspondence refinement algorithm, e.g., as described in Lucas, B. and Kanade, T. “An iterative image registration technique with application in stereo vision” (Proceedings of the 7th International Joint Conference on Artificial Intelligence, pp. 674-679). In this case, the system can use the determined correspondence between each pairing of points to extract a pixel patch, e.g., a P×P patch in both the first and second images around the respective original detected geometric feature that corresponds with each point in the correspondence set. The system can then combine the respective sub-pixel corrections with the first and second points in the pairing of points to determine an updated pairing of points in the correspondence set.

As an example, in the case that the system computes a camera-to-camera transform, the system can determine a coarse camera-to-camera transform, e.g., an initial extrinsic transformation matrix, and can apply the coarse camera-to-camera transform to project a point from the viewpoint of the first camera to the second camera using the detected geometric features and the coarse camera-to-camera transform in order to determine the correspondences between the geometric features. The system can compute point feature histograms for the first and second point clouds and use features, e.g., summary statistic features, of the first and second point feature histograms to determine an initial extrinsic transformation matrix, e.g., as described in Rusu, N. et al. “Fast Point Feature Histograms (FPFH) for 3D registration” (2009 IEEE, doi: 10.1109/ROBOT.2009.5152473) and Zhou, Q. et al. “Open3D: A Modern Library for 3D Data Processing” (arXiv: 1801.09847).

In some cases, the system can use an iterative closest point (ICP) algorithm to preliminarily align the points in the first point cloud and the points in the second point cloud using the initial extrinsic transformation matrix, e.g., as described in Besl, P. and Mckay, N. “A Method for Registration of 3D Shapes” (1992 IEEE, doi: 10.1109/34.121791). In this case, the system can use the geometric features and the coarse camera-to-camera transform, e.g., the initial extrinsic transformation matrix, to identify a correspondence set between point clouds constructed using the cameras of the first and second cameras.

The system can compute one or more calibration parameters, e.g., one or more of a set of intrinsic parameters, a set of extrinsic parameters, a camera-to-camera transform, for the pairing of cameras according to the correspondences between the geometric features in the captured images (step 240). For example, the system can use the one or more computed calibration parameters to validate one or more existing calibration parameters. As another example, the system can use the one or more computed calibration parameters to perform live adjustment of the one or more existing calibration parameters.

For example, the system can determine an extrinsic transformation matrix between the first camera and the second camera based on a measure of discrepancy between the points in the first point cloud and the second point cloud according to the correspondences between the geometric features in a first image from the first camera and the second image from the second camera. Additionally, in some cases, the system can use bundle adjustment optimization to minimize a measure of discrepancy, e.g., the reprojection error, for the pairing of points in the correspondence set, e.g., at each of a number of optimization iterations.

In some cases, the system can improve the correspondence quality used to compute the one or more calibration parameters by further optimizing on an additional constraint including a modeling of the projected ray from the projector, e.g., to simultaneously provide a calibration of the projector to each camera unit. As another example, the system can further refine the one or more calibration parameters determined using the iterative closest point (ICP) algorithm to align the points in the first point cloud, e.g., by performing one or more additional iterations of the ICP algorithm, and the points in the second point cloud by updating the initial extrinsic transformation matrix. In this case, for each optimization iteration, the system can map the first point in each pairing to the viewpoint of the second camera using the extrinsic transformation matrix at the optimization iteration and can minimize the measure of discrepancy between the mapped point and the second point in the pairing of points. For example, the system can minimize a measure of distance between each mapped point and each second point in the pairing of points in the correspondence set.

At a final optimization iteration, the system can provide the one or more calibration parameters, e.g., to a real-time control system to inform control signals determined using the at least two cameras. As another example, the system can use the calibration parameters to validate existing calibration parameters. In this case, the system can determine a measure of discrepancy between the existing calibration parameters and the computed calibration parameters, e.g., to assess calibration drift in a production setting, and can determine whether or not the measure of discrepancy satisfies a criterion based on a threshold value. In this case, the threshold value can be a determined tolerance for a measure of error.

While the process 200 is described above for a two-camera extrinsic camera calibration system, the process is not limited to two-camera systems and can be completed for any pairing of any number of two or more cameras in an environment. In particular, the system can determine geometric features between shapes in the captured images and correspondences between the geometric features for each pairing of cameras in the at least two different cameras and can compute the one or more calibration parameters for each pairing of cameras according to the respective correspondences between the geometric features in the captured images. For example, the system can identify pairings of cameras in a four camera system of Cameras A, B, C, and D as follows: Cameras A and B, Cameras A and C, Cameras A and D, Cameras B and C, Cameras B and D, and Cameras C and D and can perform process 200 for one or more of the identified pairings.

FIG. 3 illustrates the determination of a correspondence using a single stereo unit, and the determination of the transformation function between the stereo unit and a paired stereo unit. While a simplified representation is shown, FIG. 3 provides an illustration of the process described in FIG. 2.

In particular, the system can autocalibrate a single stereo unit, e.g., the stereo unit S1 350, using the projected pattern, and then combine the point cloud detected using the calibrated stereo unit with a point cloud from another paired stereo unit to determine the transformation function between the two stereo units. In this case, the projected pattern is a dot pattern.

In the example depicted, the system captures the image 302 and the image 304 using camera A and camera B of the stereo unit, respectively. The system additionally captures respective background images using both cameras of the stereo unit with the dot projector turned off (not shown), and subtracts the background image from camera A from image 302 and the background image from camera B from image 302, resulting in the image 312 and 314 of the pattern without the background.

The system then blurs the images 312 and 314, to find the local brightness maxima of each of the imaged dots. For example, the system can fit a quadratic function to the blurred shapes using brightness data of the images 312 and 314 to determine the dot centroids, e.g., depicted as x's in 322 and 324. In this case, the system can use the disparity between the dot centroids in the images 322 and 324 to determine a correspondence between camera A and camera B.

The correspondence can additionally be informed using three-dimensional depth information from the binocular vision of the stereo unit. While the mapping between points representing dot centroids A, B, and C in 332 to points representing dot centroids A′, B′, C′ in 334 is straightforward in this simplified representation, the alignment between the points can be much more complex, especially when the pattern is projected on one or more three-dimensional objects, e.g., overlapping three-dimensional objects.

The system can then triangulate between the points representing the dot centroids to form a dot point cloud 340. In this context, triangulating between the points refers to using the disparity between the points A, B, C in 332 and points A′, B′, C′ in 334 to compute three-dimensional coordinates for the points in the dot point cloud 340.

The system can perform the steps described above to calibrate a second stereo unit, e.g., concurrently or subsequently. The system can then align the point clouds from the first stereo unit 350 and second stereo unit 355, e.g., the point cloud 360 and the point cloud 365, to determine a coarse camera-to-camera transform between the stereo units, e.g., an initial extrinsic transformation matrix, and can refine the transformation using an iterative closest point (ICP) algorithm and a bundle adjustment optimization, as is described above, to determine a refined camera-to-camera transform between the paired stereo units.

The alignment of point clouds is referred to as point cloud registration. While depicted in FIG. 3 with respect to aligning the point clouds from two stereo units, the system can calibrate two or more stereo units and perform point cloud registration with the point clouds determined using each stereo unit.

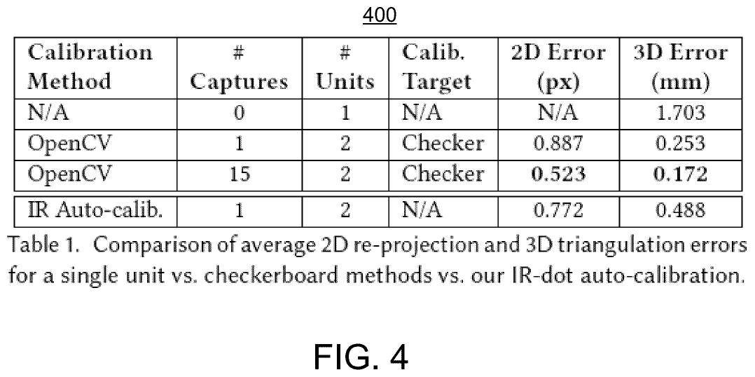

FIG. 4 includes a comparison of example results from a calibration system implemented using the techniques of this specification and a checkerboard calibration method.

Table 400 depicts results from an uncalibrated system, a calibration system implemented using the techniques of this specification, e.g., the extrinsic camera calibration system 100 of FIG. 1 with two stereo units, and a calibration system implemented using the checkerboard target-based methods of Zhang, Z. “A flexible new technique for camera calibration.” (IEEE Transactions on pattern analysis and machine intelligence 22, 11 (2000), 1330-1) implemented with the OpenCV library (Bradski., G. 2000. The opencv library. Dr. Dobb's Journal: Software Tools for the Professional Programmer 25, 11 (2000), 120-123) with both 1 and 15 captures. In the experiments performed, the systems were tasked with capturing a large 800 mm×600 mm checkerboard in different locations in a workcell.

The table 400 includes the two-dimensional (2D) reprojection error, e.g., the average difference between detected corner locations and their projections, and the three-dimensional (3D) triangulation error, e.g., the disparity between the estimated 3D positions of triangulated checkerboard corners and known positions of checkerboards. The metrics depicted in table 400 provide an evaluation of the accuracy of the estimated camera-to-camera transform, and their impact on both 2D and 3D reconstruction performance. In this context, reconstruction refers to creating a digital 2D or 3D model of an object or environment using data from the calibrated cameras.

While the results in the table 400 show using Zhang's method implemented with OpenCV with multiple captures remains the most accurate method, with error of 0.172 mm, calibrating in this manner requires multiple, e.g., 15, captures and a calibrated board, which presents challenges in an industrial setting.

In contrast, the techniques of this specification can be implemented to detect calibration drift without manual human intervention and costly downtime, and achieve robust 3D reconstruction: autocalibrating the camera-to-camera transform using the techniques described significantly enhances the 3D accuracy: from an error of 1.703 mm to 0.488 mm.

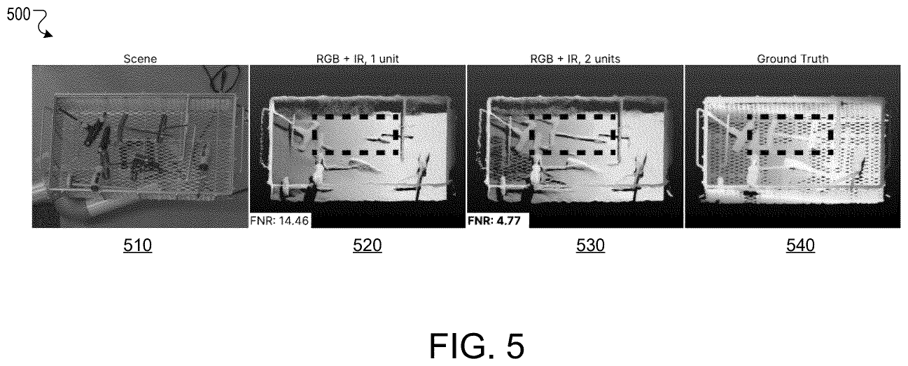

FIG. 5 illustrates how calibrating cameras using the calibration techniques of this specification can enhance the three-dimensional reconstruction of an example scene. In particular, panel 500 includes an image of an example cluttered bin scene 510, with ground truth reconstruction 540.

Panel 500 depicts how calibrating two stereo units using the techniques of this specification results in more accurate reconstruction 530 than the reconstruction 520 resulting from a standard color image captured by a single stereo unit (RGB). In particular, the reconstruction 530 shows that the calibration method can improve the separation of foreground objects, including thin objects, e.g., the screwdriver, from background textured regions in the reconstruction of the cluttered bin scene. In particular, by adding an additional stereo unit, the system can leverage multiple views and multiple baselines yielding higher reconstruction accuracy.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
projecting a pattern having a plurality of shapes in an environment using a projector;
   capturing images of the pattern from at least two different cameras;
   determining one or more geometric features of shapes in the captured images and correspondences between the geometric features for a pairing of cameras in the at least two different cameras; and
   computing one or more calibration parameters for the pairing of cameras according to the correspondences between the geometric features in the captured images.

Embodiment 2 is the method of embodiment 1, further comprising:
validating one or more existing calibration parameters using the one or more computed calibration parameters; or
performing live adjustment of the one or more existing calibration parameters using the one or more computed calibration parameters.

Embodiment 3 is the method of any one of embodiments 1-2, wherein computing the one or more calibration parameters comprises computing one or more of a set of intrinsic parameters, a set of extrinsic parameters, or a camera-to-camera transform.

Embodiment 4 is the method of embodiment 3, wherein computing the camera-to-camera transform for the pairing of cameras according to the correspondences between the geometric features in the captured images comprises:
determining an extrinsic transformation matrix between a first camera and a second camera based on a measure of discrepancy between a plurality of points in a first point cloud corresponding with the first camera and a plurality of points in a second point cloud corresponding with the second camera according to the correspondences between the geometric features in a first image from the first camera and a second image from the second camera.

Embodiment 5 is the method of any one of embodiments 1-4, wherein projecting the pattern having the plurality of shapes comprises:
projecting the pattern in the environment using a first projector; or
projecting the pattern in the environment using a second projector.

Embodiment 6 is the method of any one of embodiments 1-5, wherein capturing images of the pattern from at least two different cameras comprises capturing an image from each camera, and wherein capturing the image from each camera comprises:
capturing a background image comprising the environment without the pattern;
capturing a pattern image comprising the environment with the pattern; and
generating the image by subtracting the background image from the pattern image.

Embodiment 7 is the method of any one of embodiments 1-6, wherein determining the one or more geometric features of shapes in the captured images and the correspondences between the geometric features for the pairing of cameras comprises, for a first camera and a second camera in the pairing of cameras:
detecting a first set of geometric features corresponding with the plurality of shapes in a first image captured from the first camera and a second set of geometric features corresponding with the plurality of shapes in a second image captured from the second camera; and
using the first and second sets of geometric features to determine the correspondences between the geometric features.

Embodiment 8 is the method of embodiment 7, wherein the first and second sets of geometric features comprise:
detected centroids of each shape in the first image and second image; or
detected corners of each shape in the first image and second image.

Embodiment 9 is the method of any one of embodiments 7-8, wherein detecting the first set of geometric features for the first image and the second set of geometric features for the second image comprises, for each image:
generating a respective pattern representation comprising a plurality of elongated shapes by blurring the image; and
determining the geometric feature of each of the plurality of elongated shapes in the pattern representation.

Embodiment 10 is the method of embodiment 9, wherein determining the geometric feature of each of the plurality of elongated shapes comprises, for each elongated shape in the pattern representation:
estimating a point of maximal brightness of the elongated shape using a sliding window;
determining a quadratic fit around the estimated point of maximal brightness for the elongated shape; and
identifying a vertex of the quadratic fit as the geometric feature.

Embodiment 11 is the method of any one of embodiments 9-10, further comprising:
ranking the geometric features corresponding with the plurality of elongated shapes according to a measure of brightness of each respective elongated shape; and
selecting a subset of the geometric features based on the measure of brightness for determining correspondences.

Embodiment 12 is the method of any one of embodiments 7-11, wherein using the first and second sets of geometric features to determine the correspondences between the geometric features comprises:
identifying a correspondence set of points comprising a pairing of points from a first point cloud and second point cloud using an initial extrinsic transformation matrix and the first and second sets of geometric features, wherein the first point cloud comprises a plurality of points corresponding with the first camera and the second point cloud comprises a plurality of points corresponding with the second camera.

Embodiment 13 is method of embodiment 12, further comprising determining the initial extrinsic transformation matrix, wherein determining the initial extrinsic transformation matrix comprises:
computing a first point feature histogram and a second point feature histogram using the respective plurality of points in the first point cloud and the plurality of points in the second point cloud; and
using features of the first and second point feature histograms to determine an initial extrinsic transformation matrix.

Embodiment 14 is the method of any one of embodiments 12-13, wherein identifying the correspondence set of points using the initial extrinsic transformation matrix and the first and second sets of geometric features comprises:
using an iterative closest point algorithm to align the plurality of the points in the first point cloud and the plurality of the points in the second point cloud using the initial extrinsic transformation matrix.

Embodiment 15 is the method of embodiment 14, wherein using the iterative closest point algorithm to align the plurality of the points in the first point cloud and the plurality of the points in the second point cloud comprises, for each geometric feature in the first set of geometric features:
determining a point in the first point cloud that corresponds with the geometric feature as a first point in a pairing of points;
mapping the first point to a mapped point in a viewpoint of the second camera using the initial extrinsic transformation matrix; and
identifying a nearest corresponding point to the mapped point in the second point cloud within a specified threshold distance as a second point in the pairing of points.

Embodiment 16 is the method of any one of embodiments 12-15, further comprising, for each pairing of points in the correspondence set of points:
performing a correspondence refinement algorithm to compute respective sub-pixel corrections for the first and second points in the pairing of points; and
combining the respective sub-pixel corrections with the first and second points in the pairing of points to determine an updated pairing of points.

Embodiment 17 is the method of any one of embodiments 12-16, wherein computing the one or more calibration parameters for the pairing of cameras according to the correspondences between the geometric features in the captured images further comprises:
using bundle adjustment optimization to minimize a measure of discrepancy for each pairing of points in the correspondence set.

Embodiment 18 is the method of embodiment 17, wherein the measure of discrepancy comprises a reprojection error.

Embodiment 19 is the method of any one of embodiments 1-18, further comprising:
determining geometric features between shapes in the captured images and correspondences between the geometric features for each pairing of cameras in the at least two different cameras; and
computing the one or more calibration parameters for each pairing of cameras according to respective correspondences between the geometric features in respective captured images.

Embodiment 20 is the method of any one of embodiments 2-19, wherein validating one or more existing calibration parameters using the one or more computed calibration parameters comprises:
determining a measure of discrepancy between the one or more existing calibration parameters and the one or more computed calibration parameters; and
determining that the measure of discrepancy satisfies a criterion based on a threshold value.

Embodiment 21 is the method of any one of embodiments 1-20, wherein the pattern is visible in high ambient illumination environments.

Embodiment 22 is the method of any one of embodiments 1-21, wherein the pattern having the plurality of shapes comprises:
a pseudorandom grid of dots; or
an L pattern.

Embodiment 23 is the method of any one of embodiments 1-22, wherein the projector is a calibrated projector or an uncalibrated projector.

Embodiment 24 is a system comprising: one or more computers and one or more storage devices storing instructions that are operable, when executed by the one or more computers, to cause the one or more computers to perform the method of any one of embodiments 1 to 23.

Embodiment 25 is a computer storage medium encoded with a computer program, the program comprising instructions that are operable, when executed by data processing apparatus, to cause the data processing apparatus to perform the method of any one of embodiments 1 to 23.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
projecting a pattern having a plurality of shapes in an environment using a projector;
capturing images of the pattern from at least two different cameras;
determining one or more geometric features of shapes in the captured images and correspondences between the geometric features for a pairing of cameras in the at least two different cameras; and
computing one or more calibration parameters for the pairing of cameras according to the correspondences between the geometric features in the captured images.

2. The method of claim 1, further comprising:
validating one or more existing calibration parameters using the one or more computed calibration parameters; or
performing live adjustment of the one or more existing calibration parameters using the one or more computed calibration parameters.

3. The method of claim 1, wherein computing the one or more calibration parameters comprises computing one or more of a set of intrinsic parameters, a set of extrinsic parameters, or a camera-to-camera transform.

4. The method of claim 3, wherein computing the camera-to-camera transform for the pairing of cameras according to the correspondences between the geometric features in the captured images comprises:
determining an extrinsic transformation matrix between a first camera and a second camera based on a measure of discrepancy between a plurality of points in a first point cloud corresponding with the first camera and a plurality of points in a second point cloud corresponding with the second camera according to the correspondences between the geometric features in a first image from the first camera and a second image from the second camera.

5. The method of claim 1, wherein capturing images of the pattern from at least two different cameras comprises capturing an image from each camera, and wherein capturing the image from each camera comprises:
capturing a background image comprising the environment without the pattern;
capturing a pattern image comprising the environment with the pattern; and
generating the image by subtracting the background image from the pattern image.

6. The method of claim 1, wherein determining the one or more geometric features of shapes in the captured images and the correspondences between the geometric features for the pairing of cameras comprises, for a first camera and a second camera in the pairing of cameras:
detecting a first set of geometric features corresponding with the plurality of shapes in a first image captured from the first camera and a second set of geometric features corresponding with the plurality of shapes in a second image captured from the second camera; and
using the first and second sets of geometric features to determine the correspondences between the geometric features.

7. The method of claim 6, wherein the first and second sets of geometric features comprise:
detected centroids of each shape in the first image and second image; or
detected corners of each shape in the first image and second image.

8. The method of claim 6, wherein detecting the first set of geometric features for the first image and the second set of geometric features for the second image comprises, for each image:
generating a respective pattern representation comprising a plurality of elongated shapes by blurring the image; and
determining the geometric feature of each of the plurality of elongated shapes in the pattern representation.

9. The method of claim 8, wherein determining the geometric feature of each of the plurality of elongated shapes comprises, for each elongated shape in the pattern representation:
estimating a point of maximal brightness of the elongated shape using a sliding window;
determining a quadratic fit around the estimated point of maximal brightness for the elongated shape; and
identifying a vertex of the quadratic fit as the geometric feature.

10. The method of claim 9, further comprising:
ranking the geometric features corresponding with the plurality of elongated shapes according to a measure of brightness of each respective elongated shape; and
selecting a subset of the geometric features based on the measure of brightness for determining correspondences.

11. The method of claim 6, wherein using the first and second sets of geometric features to determine the correspondences between the geometric features comprises:
identifying a correspondence set of points comprising a pairing of points from a first point cloud and second point cloud using an initial extrinsic transformation matrix and the first and second sets of geometric features, wherein the first point cloud comprises a plurality of points corresponding with the first camera and the second point cloud comprises a plurality of points corresponding with the second camera.

12. The method of claim 11, further comprising determining the initial extrinsic transformation matrix, wherein determining the initial extrinsic transformation matrix comprises:
computing a first point feature histogram and a second point feature histogram using the respective plurality of points in the first point cloud and the plurality of points in the second point cloud; and
using features of the first and second point feature histograms to determine an initial extrinsic transformation matrix.

13. The method of claim 11, wherein identifying the correspondence set of points using the initial extrinsic transformation matrix and the first and second sets of geometric features comprises:
using an iterative closest point algorithm to align the plurality of the points in the first point cloud and the plurality of the points in the second point cloud using the initial extrinsic transformation matrix.

14. The method of claim 13, wherein using the iterative closest point algorithm to align the plurality of the points in the first point cloud and the plurality of the points in the second point cloud comprises, for each geometric feature in the first set of geometric features:
determining a point in the first point cloud that corresponds with the geometric feature as a first point in a pairing of points;
mapping the first point to a mapped point in a viewpoint of the second camera using the initial extrinsic transformation matrix; and
identifying a nearest corresponding point to the mapped point in the second point cloud within a specified threshold distance as a second point in the pairing of points.

15. The method of claim 11, further comprising, for each pairing of points in the correspondence set of points:
performing a correspondence refinement algorithm to compute respective sub-pixel corrections for the first and second points in the pairing of points; and
combining the respective sub-pixel corrections with the first and second points in the pairing of points to determine an updated pairing of points.

16. The method of claim 11, wherein computing the one or more calibration parameters for the pairing of cameras according to the correspondences between the geometric features in the captured images further comprises:
using bundle adjustment optimization to minimize a measure of discrepancy for each pairing of points in the correspondence set, wherein the measure of discrepancy comprises a reprojection error.

17. The method of claim 1, further comprising:
determining geometric features between shapes in the captured images and correspondences between the geometric features for each pairing of cameras in the at least two different cameras; and
computing the one or more calibration parameters for each pairing of cameras according to respective correspondences between the geometric features in respective captured images.

18. The method of claim 2, wherein validating one or more existing calibration parameters using the one or more computed calibration parameters comprises:
determining a measure of discrepancy between the one or more existing calibration parameters and the one or more computed calibration parameters; and
determining that the measure of discrepancy satisfies a criterion based on a threshold value.

19. A system comprising one or more computers and one or more storage devices storing instructions that are operable, when executed by the one or more computers, to cause the one or more computers to perform operations comprising:
projecting a pattern having a plurality of shapes in an environment using a projector;
capturing images of the pattern from at least two different cameras;
determining one or more geometric features of shapes in the captured images and correspondences between the geometric features for a pairing of cameras in the at least two different cameras; and
computing one or more calibration parameters for the pairing of cameras according to the correspondences between the geometric features in the captured images.

20. A computer storage medium encoded with a computer program, the program comprising instructions that are operable, when executed by data processing apparatus, to cause the data processing apparatus to perform operations comprising:
projecting a pattern having a plurality of shapes in an environment using a projector;
capturing images of the pattern from at least two different cameras;
determining one or more geometric features of shapes in the captured images and correspondences between the geometric features for a pairing of cameras in the at least two different cameras; and
computing one or more calibration parameters for the pairing of cameras according to the correspondences between the geometric features in the captured images.
